(19) United States
(12) Patent Application Publication
(10) Pub. No.: US 2021/0222038 A1
(43) Pub. Date: Jul. 22, 2021

(54) HIGH MOLAR MASS POLYMERS FROM A CONTINUOUS PROCESS

(71) Applicant: BASF SE, Ludwigshafen am Rhein (DE)

(72) Inventors: Kevin PAYNE, Wyandotte, MI (US); Afsaneh NABIFAR, Ludwigshafen (DE); John David CAMPBELL, Wyandotte, MI (US); Ulrike LICHT, Ludwigshafen (DE)

(73) Assignee: BASF SE, Ludwigshafen am Rhein (DE)

(21) Appl. No.: 17/051,336

(22) PCT Filed: Apr. 25, 2019
(86) PCT No.: PCT/US2019/029211

§ 371 Date: Oct. 28, 2020

Related U.S. Application Data
(60) Provisional application No. 62/664,412, filed on Apr. 30, 2018.

(51) Int. Cl. C09J 133/14; C09J 7/38; C08F 2/48; C08F 2/06; C08F 2/02

(52) U.S. Cl. CPC C09J 133/14; C09J 7/385; C08F 2/02; C08F 2/06; C08F 2/48

(57) ABSTRACT

A process for continuously preparing a polymer by free-radical polymerization, the process includes: continuously feeding to a reactor a mixture including about 20 wt % to about 96 wt % of a vinylic monomer, the vinylic monomer comprising a styrenic monomer, a (meth)acrylic monomer, or a mixture thereof, greater than 0 wt % to about 0.25 wt % of a polymerization initiator, and about 4 wt % to about 80 wt % of a reaction solvent; maintaining the reactor at a temperature from about 120° C. to about 190° C.; and collecting the polymer; where the polymer has a weight average molecular weight (Mw) from 20,000 g/mol to about 300,000 g/mol.

### CROSS-REFERENCE TO RELATED APPLICATIONS

This application claims the benefit of priority to U.S. Provisional Patent Application No. 62/664,412, filed on Apr. 30, 2018, the entire disclosure of which is incorporated herein by reference in its entirety.

### FIELD

The present technology is generally related to processes for preparing high molecular weight polymers from a continuous process.

### BACKGROUND

High performance pressure-sensitive adhesives require a high molecular weight to obtain good cohesive strength and a low glass transition temperature (T_{g}) to achieve good adhesion. Crosslinking of the pressure-sensitive adhesive upon coating to a substrate can further improve the cohesive strength and resistance properties.

Typically, higher performance pressure-sensitive adhesives are produced by a solvent-borne technology. However, such solution phase processes typically require long reaction times and reactor shut-down in batch processes for clean-up and during start-up. Producing a high molecular weight polymer in continuous processes, with minimal residual monomer and/or solvent, would be beneficial for properties of the final polymer in addition to health and safety considerations.

### SUMMARY

In one aspect a process for continuously preparing a polymer by free-radical polymerization, the process comprising: continuously feeding to a reactor a mixture comprising: about 20 wt % to about 96 wt % of a vinylic monomer, the vinylic monomer comprising a styrenic monomer, a (meth)acrylic monomer, or a mixture thereof; greater than 0 wt % to about 0.25 wt % of a polymerization initiator; and about 4 wt % to about 80 wt % of a reaction solvent; maintaining the reactor at a temperature from about 120° C. to about 190° C.; and collecting the polymer; wherein: the polymer has a weight-average molecular weight (M_{w}) from about 20,000 g/mol to about 300,000 g/mol. In some embodiments, the process comprises continuously feeding to a reactor a mixture comprising: about 20 wt % to about 80 wt % of a vinylic monomer, the vinylic monomer comprising a styrenic monomer, a (meth)acrylic monomer, or a mixture thereof; greater than 0 wt % to about 0.25 wt % of a polymerization initiator; and about 20 wt % to about 80 wt % of a reaction solvent; maintaining the reactor at a temperature from about 120° C. to about 165° C.; and collecting the polymer; wherein: the polymer has a weight-average molecular weight (M_{w}) from about 20,000 g/mol to about 300,000 g/mol.

In another aspect, a pressure sensitive adhesive is provided, which includes a polymer produced by any of the above processes.

### BRIEF DESCRIPTION OF THE DRAWINGS

FIG. 1 is a graph of weight-average molecular weight obtainable at different reaction temperatures in a continuous stirred-tank reactor, according to the examples.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, the term “substituted,” unless specifically defined differently, refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like. For some groups, substituted may provide for attachment of an alkyl group to another defined group, such as a cycloalkyl group.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, isobutyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group. In general, alkyl groups may include in addition to those listed above, but are not limited to, 2-pentyl, 2-methylbutyl, 3-methylbutyl, 1,2-dimethylpropyl, 1,1-dimethylpropyl, 2,2-dimethylpropyl, 1-ethylpropyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, 2-heptyl, 3-heptyl, 2-ethylpentyl, 1-propylbutyl, 2-ethylhexyl, 2-propylheptyl, 1,1,3,3-tetramethylbutyl, nonyl, decyl, n-undecyl, n-dodecyl, n-tridecyl, iso-tridecyl, n-tetradecyl, n-hexadecyl, n-octadecyl, n-eicosyl, and the like.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms is 3, 4 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

As used herein, the term “acrylic-containing group” or “methacrylate-containing group” refers to a compound that has a polymerizable acrylate or methacrylate group.

As used herein, the term “polyol” refers to an oligomer that includes 2 or more monomer units wherein each monomer unit has at least one alcohol functionality.

As used herein, the term “repeat unit” refers to a structurally repeating unit of a polymer. A repeat unit may be a monomeric unit or an oligomeric unit (i.e., includes two or more monomeric units).

As used herein, the term “backbone” refers to a longest chain a polymer.

As used herein, the term “oligomer” refers to a structure that contains a relatively small number of monomeric units. As used herein, the term includes any structure having two or more monomeric units.

As used herein, the term “polymer” refers to a molecule that contains one or snore monomer units.

The hydroxyalkyl acrylates and methacrylates may contain an alkylene group having from 2 to 6 carbon atoms to which the hydroxy group is attached. Examples of these monomers are hydroxyethyl acrylate or methacrylate, hydroxypropyl acrylate or methacrylate and hydroxyhexyl acrylate or methacrylate. Other copolymerizable monomers can also be utilized. Examples of thermosetting polymers include, without limitation, terpolymers, such as styrene/2-ethylhexyl acrylate/hydroxyethyl methacrylate, styrene/methyl methacrylate/hydroxyethyl methacrylate and styrene/butyl acrylate/hydroxyethyl methacrylate. The styrenic monomers are employed in amounts from about 20% to about 50% by weight, the alkyl esters of acrylic or methacrylic acid are employed in amounts from about 10% to about 40% by weight, and the hydroxy monomers are employed in amounts from about 20% to about 50% by weight.

Examples of curing or cross-linking agents which may be utilized for cross-linking the polymeric products include, without limitation, polyepoxides, polyisocyanates, urea-aldehyde, benzoguanamine aldehyde, melamine-aldehyde condensation products, and the like. Examples of melamine-formaldehyde condensation products that act as crosslinking agent include, without limitation, polymethoxymethyl melamines such as hexamethoxymethylmelamine. When melamine-formaldehyde or urea-formaldehyde crosslinking agents are utilized, an acid catalyst, such as toluene sulfonic acid, may be employed to increase the crosslinking rate. Typically, these cross-linking agents are products of reactions of melamine or urea, with formaldehyde and various alcohols containing up to and including four carbon atoms.

“Ethylenic monomers” refer to, vinyl acetate, vinyl pyridine, vinyl pyrrolidone, sodium crotonate, methyl crotonate, crotonic acid, maleic anhydride, and the like.

“Hydrogenation” refers to chemically adding a hydrogen molecule to a compound. Olefinic or carbon-carbon double bonds (C═C) can be hydrogenated or undergo hydrogenation. While a variety of hydrogen sources can be employed for hydrogenation, a convenient source is molecular hydrogen. A variety of catalysts are useful to catalyze hydrogenations. Examples of catalysts include, without limitation, Pt, Pd, PtO₂, Pd(OH)₂, Rh, and many other suitable heavy metals dispersed on a variety of supports. Suitable supports include, without limitation, carbon, charcoal, alumina, and the like. Hydrogenations can be performed using hydrogen at atmospheric pressure and at higher pressures.

“Hydrogenated styrenic (meth)acrylic oligomer” refers to an styrenic (meth)acrylic oligomer that contains a lower level of unsaturation or fewer carbon-carbon double bonds than that present in an styrenic (meth)acrylic oligomer obtained from vinylic monomers via a bulk polymerization process. In a hydrogenated styrenic (meth)acrylic oligomer, many of the terminal double bonds present in a styrenic (meth)acrylic oligomer are hydrogenated; and other than that difference, the hydrogenated styrenic (meth)acrylic oligomer typically has the same constituent monomers as a corresponding non-hydrogenated styrenic (meth)acrylic oligomer. The terminal C═C bonds absorb UV radiation in the range from 240 nm to 275 nm and IR radiation in the range from 1645 cm⁻¹ to 1610 cm⁻¹. Therefore, the UV absorption at 240 nm to 275 nm, and IR absorption at 1645 cm⁻¹ to 1610 cm⁻¹ is lower for a hydrogenated styrenic (meth)acrylic oligomer compared to a corresponding non-hydrogenated styrenic (meth)acrylic oligomer. As used herein, one of ordinary skill will appreciate that when comparing UV or IR absorbance of two polymers (or articles made from them) as discussed above, the thickness of polymeric films or the concentration of the polymeric solutions used will impact the result. Therefore, the absorbance values obtained should be normalized with respect to the thickness, concentration, or such other parameters of the polymers or articles made from them.

“Absorbance” refers to the amount of radiation absorbed by an irradiated sample. Absorbance, A, is equal to the multiplication product of quantities E, c and l, where E is the molar or mass extinction coefficient, c is the concentration of the sample (e.g., a polymer or an oligomer) in the film or solution or dispersion, and l is the path length (thickness of the film or the width of the cuvette in which the solution or dispersion is contained). Therefore, to properly compare the absorbances of two different polymers or oligomers, parameters such as concentration, and thickness of a film or the path length should be appropriately considered.

“Polydispersity ratio” or “polydispersity index” refers to M_{w}/Mₙ, or ratio of weight average molecular weight to number average molecular weight. Polymers or oligomers having the same average molecular weight, but having a different molecular polydispersity possess different solution viscosities. The product with the higher polydispersity has a higher solution viscosity, because high molecular weight fractions make a significantly greater contribution toward viscosity than low molecular weight fractions.

“Resins” refer to compositions including some amounts of a polymer or an oligomer.

“Styrenic (meth)acrylic oligomer,” refers to polymers and oligomers having polymeric units derived from styrenic monomers and from (meth)acrylic monomers. Styrenic (meth)acrylic oligomers can contain from about 75% to about 99% non-volatile components. In some embodiments, the styrenic (meth)acrylic oligomers contain from about 90% to about 99% non-volatile components. Styrenic (meth)acrylic oligomers have a polydispersity ratio or index from about 1.5 to about 20. In some embodiments, the styrenic (meth)acrylic oligomer has a polydispersity ratio from about 1.5 to about 5. In some embodiments, the styrenic (meth)acrylic oligomer has a polydispersity ratio from about 1.5 to about 3. In some embodiments, the styrenic (meth)acrylic oligomer has a polydispersity ratio of about 1.7. In some embodiments, the styrenic (meth)acrylic oligomer has a polydispersity ratio of about 7 to about 19. Styrenic (meth)acrylic oligomers have a number average molecular weight (Mₙ) of about 1,000 g/mol to about 20,000 g/mol. In some embodiments, Mn is less than about 5000 g/mol. In some embodiments, the Mₙ is from about 1000 g/mol to about 3000 g/mol. In some embodiments, the Mₙ is from about 1000 g/mol to about 2500 g/mol. In some embodiments, the Mₙ is from about 12,000 g/mol to about 20,000 g/mol. A narrow molecular weight distribution allows for production of polymers with significantly lower content of high and low molecular weight fractions. Reduction of these high and low molecular weight fractions results in improved performance and lower viscosity in a given molecular weight range. In some embodiments, styrenic (meth)acrylic oligomers contain no styrenic monomers.

It has now been found that high molar mass (meth)acrylic polymers are obtainable by a high temperature continuous process. Incorporation of a polymerizable photoinitiator provides crosslinking by ultraviolet light (UV light) after coating on to a substrate. The final polymer is a 100% solids product with low migratables. Co-polymerization with other hydrogen bonding monomers provides a significant improvement in cohesive strength of a pressure sensitive adhesive prepared from the high molar mass polymer.

In a first aspect, a process is provided for continuously preparing a polymer by free-radical polymerization. The process includes continuously feeding to a reactor a mixture comprising: about 20 wt % to about 96 wt % of a vinylic monomer, the vinylic monomer comprising a styrenic monomer, a (meth)acrylic monomer, or a mixture thereof; greater than 0 wt % to about 0.25 wt % of a polymerization initiator; and about 4 wt % to about 80 wt % of a reaction solvent; maintaining the reactor at a temperature from about 120° C. to about 190° C.; and collecting the polymer; where the polymer has a weight-average molecular weight (M_{w}) from about 20,000 g/mol to about 300,000 g/mol. In some embodiments, the process includes continuously feeding to a reactor a mixture comprising: about 20 wt % to about 80 wt % of a vinylic monomer, the vinylic monomer comprising a styrenic monomer, a (meth)acrylic monomer, or a mixture thereof; greater than 0 wt % to about 0.2 wt % of a polymerization initiator; and about 20 wt % to about 80 wt % of a reaction solvent; maintaining the reactor at a temperature from about 120° C. to about 165° C.; and collecting the polymer; where the polymer has a weight-average molecular weight (M_{w}) from about 20,000 g/mol to about 300,000 g/mol.

In some embodiments of the process, the vinylic monomer includes both a styrenic monomer and a (meth)acrylic monomer, or the vinylic monomer may be just a (meth)acrylic monomer. As used herein, “(meth)acrylic monomers” refer to acrylic or methacrylic acid, esters of acrylic or methacrylic acid, and salts, amides, and other suitable derivatives of acrylic or methacrylic acid, and mixtures thereof. Examples of suitable acrylic monomers include, without limitation, the following methacrylate esters: methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate and tetrahydropyranyl methacrylate. Example of suitable acrylate esters include, without limitation, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate. Examples of other suitable acrylic monomers include, without limitation, methacrylic acid derivatives such as: methacrylic acid and its salts, methacrylonitrile, methacrylamide, N-methylmethacrylamide, N-ethylmethacrylamide, N,N-diethylmethacrylamide, N,N-dimethylmethacrylamide, N-phenylmethacrylamide and methacrolein. Examples of acrylic acid derivatives include, without limitation, acrylic acid and its salts, acrylonitrile, acrylamide, methyl α-chloroacrylate, methyl 2-cyanoacrylate, N-ethylacrylamide, N,N-diethylacrylamide, and acrolein. Examples of certain other suitable acrylic or methacrylic acid derivatives include, without limitation, those containing cross-linkable functional groups, such as hydroxy, carboxyl, amino, isocyanate, glycidyl, epoxy, allyl, and the like. Examples of hydroxy functional monomers include, without limitation, hydroxyalkyl acrylates and methacrylates such as 2-hydroxyethyl acrylate (HEA), 3-chloro-2-hydroxypropyl acrylate, 2-hydroxy-butyl acrylate, 6-hydroxyhexyl acrylate, 2-hydroxymethyl methacrylate (HMMA), 2-hydroxypropyl methacrylate (HPMA), 6-hydroxyhexyl methacrylate, and 5,6-dihydroxyhexyl methacrylate. Any of the above materials may be used alone or in combination with any other of the above materials.

In some embodiments of the process, the (meth)acrylic monomer comprises acrylic acid, methacrylic acid, methylmethacrylic acid, methylmethacrylate, ethylmethacrylate, a hydroxy vinyl ether, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate, methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate, tetrahydropyranyl methacrylate, hydroxyalkyl acrylates and methacrylates, acrylic acid and its salts, acrylonitrile, acrylamide, methyl a-chloroacrylate, methyl 2-cyanoacrylate, N-ethylacrylamide, N,N-diethylacrylamide, acrolein, methacrylic acid and its salts, methacrylonitrile, methacrylamide, N-methylmethacrylamide, N-ethylmethacrylamide, N,N-diethylmethacrylamide, N,N-dimethylmethacrylamide, N-phenylmethacrylamide, methacrolein, or a mixture of any two or more thereof. In some embodiments, the (meth)acrylate comprises an alkanol (meth)acrylate ester. In other embodiments, the (meth)acrylate comprises methyl (meth)acrylate.

In some embodiments of the process, the (meth)acrylic monomer comprises ethyl acrylate, methyl (meth)acrylate, butyl (meth)acrylate, 2-ethylhexyl (meth)acrylate, hydroxyethyl (meth)acrylate, glycidyl (meth)acrylate, acrylic acid, (meth)acrylic acid, hydroxy propyl (meth)acrylate, or hydroxy butyl(meth)acrylate.

As used herein, “styrenic monomer” may refer to, α-methyl styrene (AMS), styrene (Sty), vinyl toluene, tertiary butyl styrene, o-chlorostyrene, and the like. In some embodiments of the process, the styrenic monomer comprises styrene or α-methylstyrene. In some embodiments of the process, the styrenic monomer comprises styrene and the (meth)acrylic monomer comprises glycidyl (meth)acrylate. In some embodiments, the vinylic monomer may include from about 40 to about 65 wt % of the styrenic monomer; and from about 35 to about 60 wt % (meth)acrylic monomer.

According to the process, the reactor may be continuously charged with a polymerization initiator. The photoinitiators suitable for carrying out the process may thermally decompose into radicals in a first order reaction. Suitable initiators include those with half-life periods in the radical decomposition process of 1 hour at temperatures greater or equal to 90° C., and further include those with half-life periods in the radical decomposition process of 10 hours at temperatures greater or equal to 100° C. Others with 10 hour half-lives at temperatures lower than 100° C. may also be used. For example, and without limitation, the polymerization initiators may include, but is not limited to, 2,2′-azodi-(2,4-dimethylvaleronitrile); 2,2′-azobisisobutyronitrile (AIBN); 2,2′-azobis(2-methylbutyronitrile); 1,1′-azobis (cyclohexane-1-carbonitrile); tertiary butylperbenzoate; tert-amyl peroxy 2-ethylhexyl carbonate; 1,1-bis(tert-amylperoxy)cyclohexane, tert-amylperoxy-2-ethylhexanoate, tert-amylperoxyacetate, tert-butylperoxyacetate, tert-butylperoxybenzoate (TBPB), 2,5-di-(tert-butylperoxy)-2,5-dimethylhexane, di-tert-amyl peroxide (DTAP); di-tert-butylperoxide (DTBP); lauryl peroxide; dilauryl peroxide (DLP), succinic acid peroxide; or benzoyl peroxide. In some embodiments, the polymerization initiator includes 2,2′-azodi-(2,4-dimethylvaleronitrile); 2,2′-azobisisobutyronitrile (AIBN); or 2,2′-azobis(2-methylbutyronitrile). In other embodiments, the polymerization initiator includes di-tert-amyl peroxide (DTAP); di-tert-butylperoxide (DTBP); lauryl peroxide; succinic acid peroxide; or benzoyl peroxide.

As noted above, the process may include the use of a polymerizable photoinitiator either alone or in combination with any one or more of the above photoinitiators. Where a polymerizable photoinitiator is included in the reaction mixture, it may be a compound of Formula:

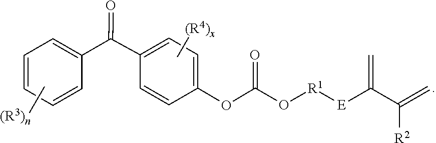

In the above compound, R¹ is a linker group; R² is H or alkyl; E is O or NR⁵; each R³ is individually a substituent selected from the group consisting of halogen, alkyl, O-alkyl, cycloalkyl, and an alkyl group containing a heteroatom, a halogen, a carbonyl group, alkoxy, or amino group; each R⁴ is individually a substituent selected from the group consisting of alkyl, O-alkyl, cycloalkyl, and an alkyl group containing a heteroatom, a halogen, a carbonyl group, alkoxy, or amino group; R⁵ is H or alkyl; n is 0-5; and x is 0-4. R¹ may be an alkyl, cycloalkyl, alkyloxy, alkylamino, aryl, or arylamino group. In some embodiments, R¹ is arylene, cycloalkylenyl, —[C(R⁶)(R⁷)]_{n′}—, or —{[C(R⁶)(R⁷)]_{n′}C(O)}_{x′}[O(C(R⁶)(R⁷))_{q}]ₚ—; each R⁶ is individually H, OR¹⁰, alkyl, or C(O)OH; each R⁷ is individually H, OR¹⁰, or alkyl, where each R¹⁰ is individually H or alkyl; n′ is 1-12; q is 1, 2, or 3; p is 1, 2, or 3; and x′ is 1-10. In other embodiments, R¹ is —(CH₂)_{n′}—, cyclohexan-1,4-yl, phenylen-1,4-yl, —[(CH₂)₃C(O)]₂—O—(CH₂)_{q}—, —C(CH₃)(C(O)OH)—, —C(H)(phenyl)C(CH₃)(H)—, or —CH₂C(CH₃)₂CH₂—; and q is 1, 2, or 3. In other embodiments, R¹ is —(CH₂)₃—; E is O; n is 0, x is 0, and R² is H or methyl. Illustrative R¹ groups include, but are not limited to, —(CH₂)_{y}—, —(CH₂CH₂O)ₓ(CH₂)_{y}—, aryl, —(CH₂C(R³)₂CH₂)—, —(CH₂C(aryl)(H)CH(CH₃))—, —(C(R³)(COOH))—, -(cyclohexyl)-, -phenyl-, and —(CH₂)_{y}C(O)O(CH₂)_{y}—.

In some embodiments, R³ and R⁴ are individually F, Cl, Br, I, C₁-C₈-alkyl, O-(C₁-C₈-alkyl), C₁-C₁₂-cycloalkyl, —C(O)(C₁-C₁₀-alkyl), (C₁-C₁₀-alkyl)C(O)(C₁C₁₀-alkyl), or an alkyl group with a substituent selected from F, Cl, Br, I, —OR¹⁰, NR¹¹R¹², where R¹⁰, R¹¹, and R¹² are individually H or alkyl.

Illustrative compounds of the Formula include, but are not limited to:

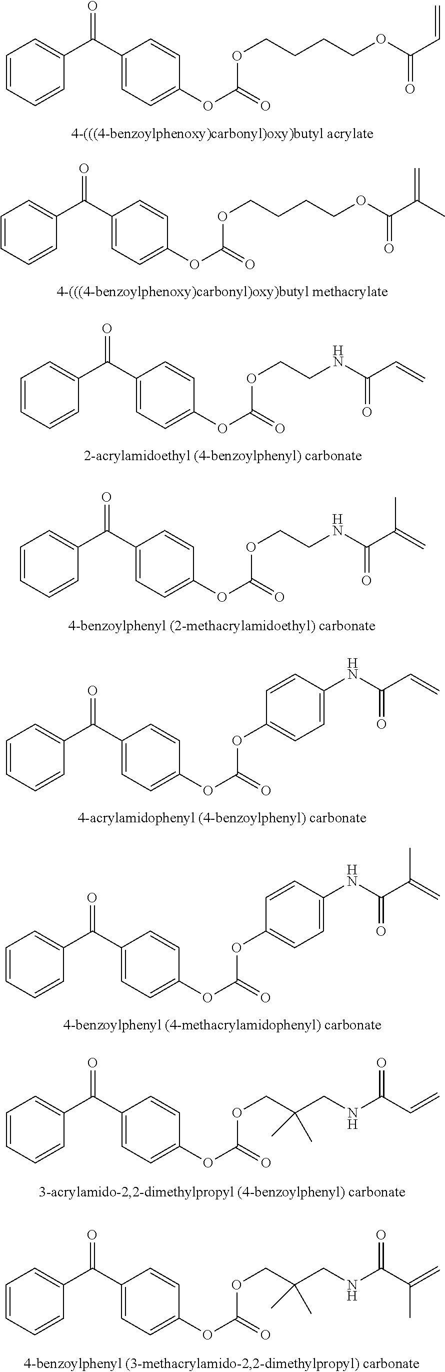

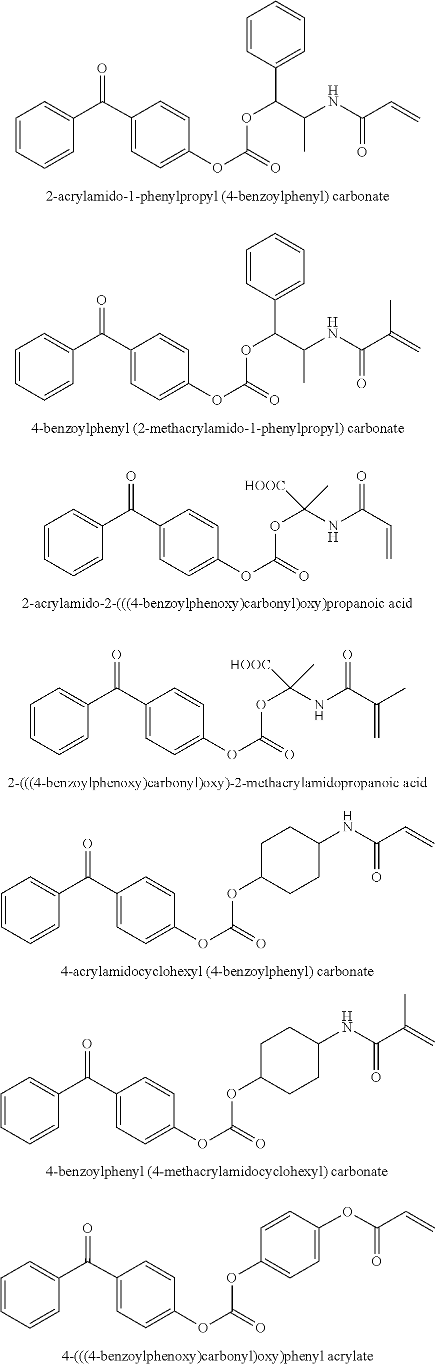

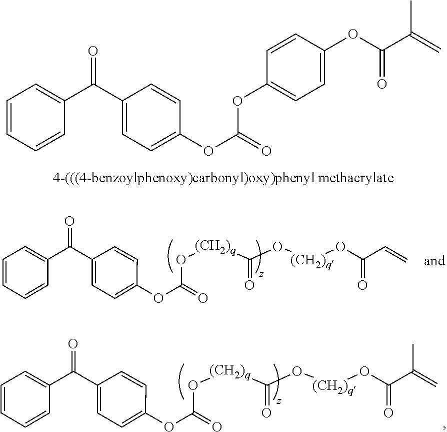

wherein: each of q, q′, and z are individually 1-10. In some embodiments, each of q, q′, and z are individually 1, 2, 3, 4, or 5. Other polymerizable photoinitiators may include, but are not limited to, those that may be sold under the Irgacure®, Omnirad®, or Darocur®. Additional materials that may be used include, but are not limited to, (2-oxo-1,2-diphenyl-ethyl)-prop-2-enoate, phenyl-(1-acryloyloxy)-cyclohexyl ketone, 2-hydroxy-1-[4-(2-acryloyloxyethoxy)phenyl]-2-methyl-1-propanone, and 4-acryloyloxybenzophenone. Further materials include (meth)acrylated thioxanthones as disclosed in CA 2005283 and CA 1180486; (meth)acrylated benzophenones as disclosed in US 2006/0142408 and GB 925117; (meth)acrylated a-hydroxy-ketones as disclosed in WO 2005/108452, WO 97/17378 and EP 538553; (meth)acrylated alpha-amino ketones as disclosed in WO 96/20919 and CA 2005283; (meth)acrylated acyl phosphine oxide initiators as disclosed in WO 2006/056541, WO 2004/103580 and AU 2003205731; and (meth)acrylated benzil dialkyl acetals as disclosed in JP 2005-082679.

The polymerization initiator(s) may be present from greater than 0 wt % to about 0.25 wt %, based upon the solids of the reaction. In some embodiments, the polymerization initiator is present from about 0.01 wt % to 0.25 wt %, based upon the solids of the reaction. In some embodiments, the polymerization initiator is present from about 0.01 wt % to 0.20 wt %, based upon the solids of the reaction. In some embodiments, the polymerization initiator is present from about 0.01 wt % to 0.15 wt %, based upon the solids of the reaction. In some embodiments, the polymerization initiator is present from about 0.05 wt % to 0.15 wt %, based upon the solids of the reaction.

The polymerizable photoinitiator(s) may be present from about 0 wt % to about 5.0 wt %, based upon the solids of the reaction. In some embodiments, the polymerizable photoinitiator is present from about 0.01 wt % to 5.0 wt %, based upon the solids of the reaction. In some embodiments, the polymerizable photoinitiator is present from about 0.1 wt % to 3.0 wt %, based upon the solids of the reaction. In some embodiments, the polymerizable photoinitiator is present from about 0.5 wt % to 3.0 wt %, based upon the solids of the reaction. In some embodiments, the polymerizable photoinitiator is present from about 0.5 wt % to 2.0 wt %, based upon the solids of the reaction

In the process, the reaction solvent may include acetone, aromatic 100, aromatic 150, aromatic-200, ethyl-3-ethoxypropionate, methyl amyl ketone, methylethylketone, methyl-iso-butylketone, N-methylpyrrolidone, (propylene glycol monomethyl ether acetate, xylene, toluene, ethyl benzene, carbitol, cyclohexanol, dipropylene glycol (mono)methyl ether, n-butanol, n-hexanol, hexyl carbitol, iso-octanol, iso-propanol, methyl cyclohexane methanol, decyl alcohol, lauryl alcohol, myristal alcohol, cetyl alcohol, stearyl alcohol, behenyl alcohol, isoparaffins, or a mixture of any two or more thereof. In some embodiments, the reaction solvent is present from about 0 wt % to 80 wt %, based upon the total mass of the reaction. In some embodiments, the reaction solvent is present from about 2 wt % to 60 wt %, based upon the total mass of the reaction. In some embodiments, the reaction solvent is present from about 4 wt % to 40 wt %, based upon the total mass of the reaction. In some embodiments, the reaction solvent is present from about 4 wt % to 20 wt %, based upon the total mass of the reaction.

In any of the above embodiments of the process, the mixture may further include N-vinyl pyrrolidone from about 0 to ≤15 wt %, based upon the solids of the reaction. In some embodiments, the N-vinyl pyrrolidone is present from about 0.01 wt % to 15 wt %, based upon the solids of the reaction. In some embodiments, the N-vinyl pyrrolidone is present from about 0.1 wt % to about 10 wt %, based upon the solids of the reaction. In some embodiments, the N-vinyl pyrrolidone is present from about 1 wt % to 8 wt %, based upon the solids of the reaction. According to inventors and the data in Table 2, the amount of NVP can be 0 wt % if the Mw is in the higher part of the range.

As noted above, the weight average molecular weight (M_{w}) of the polymer of the process may be from about 20,000 to about 300,000 g/mol. This may include from about 30,000 g/mol to 300,000 g/mol; from about 30,000 g/mol to 250,000 g/mol; from about 35,000 g/mol to 200,000 g/mol; or from about 35,000 g/mol to 150,000 g/mol.

The continuous processes described herein may be conducted in a continuously stirred tank reactor (“CSTR”), which is a tank reactor provided with cooling coils and/or cooling jackets. The cooling coils and/or the cooling jackets provide for sufficient removal of the heat of polymerization not taken up by raising the temperature of the continuously charged monomer composition to maintain a preselected temperature for polymerization therein. Such a CSTR may be provided with at least one, and usually more, agitators to provide a well-mixed reaction zone. Such CSTR may be operated at varying filling levels from about 20% to 100% full (liquid full reactor LFR). In one embodiment, the reactor is more than 50% full but less than 100% full. In another embodiment the reactor is 100% liquid full.

The continuous polymerization is carried out at temperatures that are lower than those used for customary bulk polymerization processes for producing such oligomers. In one embodiment, the polymerization temperatures range from about 120° C. to about 190° C. In another embodiment, the polymerization temperature is from about 120° C. to about 165° C. In another embodiment, the polymerization temperature is from about 120° C. to about 150° C. In another embodiment, the polymerization temperature is from about 140° C. to about 150° C.

The polymers and oligomers produced by any of the above process may find application in pressure sensitive adhesives. The pressure sensitive adhesives described herein may advantageously be used in the manufacture of adhesive articles including, but not limited to, industrial tapes and transfer films, including both single and double face tapes, as well as supported and unsupported free films. Also included, without limitation, are labels, decals, name plates, decorative and reflective materials, reclosable fasteners, theft prevention and anti-counterfeit devices. Various articles may advantageously be manufactured using the described pressure sensitive adhesive as a laminating adhesive to bond breakable or otherwise brittle substrates such as glass to flexible substrates made of, e.g., polymer films such as polyvinyl butyral (PVB), polypropylene, polyamide and polyester. Included are LCD displays, plate glass for use in windows, doors, partitions and the like for commercial and residential uses. The pressure sensitive adhesive is advantageously used in end use applications where the manufacture article is subjected to vibration, stress or is vulnerable or prone to impact.

The present invention, thus generally described, will be understood more readily by reference to the following examples, which are provided by way of illustration and are not intended to be limiting of the present invention.

### EXAMPLES

General. Measurement of Polymer Molecular Weight by GPC. To measure molecular weight of the example polymers, the polymeric resin was first dissolved in a solution of tetrahydrofuran (THF) solvent then injected into a Gel Permeation Chromatogram (Waters 2695 instrument coupled with Waters 2410 Refractive Index Detector). One pair of PLGEL MIXED B columns with one guard column was used and Millennium software was used to determine the number-average molecular weight (Mn), weight-average molecular weight (Mw) and z-average molecular weight (Mz) of the polymer.

Example 1. The experiments were carried out in a continuous stirred-tank reactor (CSTR), and various reactor temperatures ranging from 140 to 155° C. were used. Feed rates were varied to obtain typical residence times between 10 to 15 minutes. A typical feed composition includes a monomer mixture, polymerizable photoinitiator, free radical initiator, and solvent. For each experiment, the monomers were mixed with solvent and initiator and continuously charged to the CSTR, and product simultaneously withdrawn. The product was charged to a heated evaporator to remove as much residual monomer and solvent as needed. Table 1 shows the polymeric resins prepared.

TABLE 1
Resin Feed Composition for Examples Produced High Molar
Mass Polymers from a Continuous Process

| Feed | 1 | 2 | 3 | 4 | 5 | 6 |
|---|---|---|---|---|---|---|
| n-BA | 60.15 | 64.8 | 66.8 | 72.6 | 81.1 | 71.62 |
| n-BMA | 8 | 8 | 8 | 8 | 0 | 0 |
| AA | 4.14 | 4 | 4 | 4.1 | 5.5 | 5 |
| NVP | 6.53 | 2 | 0 | 2 | 0 | 2.1 |
| Solvent | 19.80 | 19.8 | 19.8 | 12 | 12 | 20 |
| Polymerizable | 1.18 | 1.2 | 1.2 | 1.2 | 1.3 | 1.2 |
| Photoinitiator | | | | | | |
| Free Radical | 0.2 | 0.2 | 0.2 | 0.1 | 0.1 | 0.08 |
| Initiator | | | | | | |
| Reactor | 140 | 140 | 140 | 155 | 155 | 155 |
| Temp. (° C.) | | | | | | |
| Residence | 10 | 15 | 10 | 12.5 | 10 | 10 |
| Time (min) | | | | | | |
| Mₙ | 18100 | 14900 | 14700 | 14300 | 13800 | 12800 |
| M_{w} | 211000 | 125700 | 112300 | 178100 | 261100 | 103600 |
| M_{w}/Mₙ | 11.6 | 8.4 | 7.6 | 12.5 | 18.8 | 8.1 |

n-BA = n-butyl acrylate;
n-BMA = n-butyl methacrylate, AA = acrylic acid, NVP = N-vinyl pyrrolidone, Polymerizable Photoinitiator = 4-Acryloxylbutylencarbonatobenzophenone (30% solution in methylethyl ketone), Solvent = Acetone, Free Radical Initiator = tert-amylperoxy 2-ethylhexanoate, tert-amyl peroxyacetate, M_{w} is the weight average molecular weight (g/mol), and Mₙ is the number average molecular weight (g/mol).

Example 2. Adhesive Testing of Polymeric Resin. A quart sized can of polymeric resin was placed in a heated oven at about 100-140° C. A 1.5 mil polyethylene terephthalate (PET) film was placed on a draw down table, at a temperature of about 100-140° C., under vacuum, and the heated polymer (“molten polymer”) was coated onto the PET film by knife coating. The coating was checked for coat weight accuracy before being irradiated with UV-C light with a measured dose by a Power Puck. The UV-C crosslinked adhesive was then tested for loop tack using PSTC-16, 180° peel using PSTC-101, and cohesion strength or shear using PSTC-107. Each procedure is described in the Pressure Sensitive Tape Council (PSTC) 15^{th} Edition Test Method Manual. Table 2 demonstrates cohesive strength (shear) versus adhesive strength (peel) of a pressure sensitive adhesive with varying amounts of N-vinyl pyrrolidone.

TABLE 2
Cohesive strength (shear) versus adhesive strength (peel) of a pressure
sensitive adhesive with varying amounts of N-vinyl pyrrolidone.

| Resin | N-Vinyl | 180° Peel, | Shear |
|---|---|---|---|
| | Pyrrolidone | SS | 1″ × 1″ × l kg |
| Example | (wt %) | (1 b/in) | (min) |
| 1 | 6.53 | 4.86 | 8000 |
| 2 | 2 | 4.81 | 3348 |
| 3 | 0 | 5.12 | 257 |
| 4 | 2 | 3.45 | 3656 |
| 5 | 0 | 3.27 | 6570 |
| 6 | 2.1 | 5.16 | 6189 |

Target coat weight of 50 g/m² and UV-C cure energy of 60 mJ/cm²; maximum shear measured: 8000 minutes.

Example 3. Using the continuous process described in Example 1, the high molar mass polymers of Table 3 were obtained.

TABLE 3
Resin Feed Composition, Reaction Temperatures (T_{R}), and
Residence Time (RT) for Examples Produced High Molar Mass Polymers from a Continuous
Process

| | | n- | | | | | | | | | | |
|---|---|---|---|---|---|---|---|---|---|---|---|---|
| | BA | BMA | AA | NVP | Solvent | PI | Init | RT | T_{R} | Mn | Mw | Mw/ |
| Exp | (wt %) | (wt %) | (wt %) | (wt %) | (wt. %) | (wt %) | (wt. %) | (min) | (° C.) | (kDa) | (kDa) | Mn |
| 1 | 90.9 | 0 | 5 | 0 | 4 | 0 | 0.1 | 12 | 195 | 3.4 | 15.6 | 4.6 |
| 2 | 90.9 | 0 | 5 | 0 | 4 | 0 | 0.1 | 12 | 190 | 3.9 | 20.8 | 5.4 |
| 3 | 90.9 | 0 | 5 | 0 | 4 | 0 | 0.1 | 12 | 185 | 4.0 | 33.2 | 8.3 |
| 4 | 90.9 | 0 | 5 | 0 | 4 | 0 | 0.1 | 12 | 180 | 4.9 | 97.8 | 20.1 |
| 5 | 77.9 | 0 | 4.1 | 0 | 16 | 0 | 2 | 12 | 160 | 3.2 | 10.8 | 3.4 |
| 6 | 85.8 | 0 | 4.5 | 0 | 8 | 0 | 2 | 12 | 160 | 3.6 | 15.7 | 4.3 |
| 7 | 78.85 | 0 | 4.15 | 0 | 16 | 0 | 1 | 12 | 160 | 3.9 | 15.8 | 4.0 |
| 8 | 71.25 | 0 | 3.75 | 0 | 24.9 | 0 | 0.1 | 12 | 150 | 9.1 | 79.3 | 8.7 |
| 9 | 71.25 | 0 | 3.75 | 0 | 24.9 | 0 | 0.1 | 12 | 160 | 6.2 | 26.1 | 4.2 |
| 10 | 79.55 | 0 | 4.2 | 0 | 16.15 | 0 | 0.1 | 12 | 150 | 10.9 | 75.6 | 6.9 |
| 11 | 79.55 | 0 | 4.2 | 0 | 16.15 | 0 | 0.1 | 12 | 160 | 10.2 | 118.3 | 11.6 |
| 12 | 71.25 | 0 | 3.75 | 0 | 24.9 | 0 | 0.1 | 12 | 145 | 11.2 | 95.5 | 8.6 |
| 13 | 71.25 | 0 | 3.75 | 0 | 24.9 | 0 | 0.1 | 12 | 140 | 11.1 | 124.2 | 11.2 |
| 14 | 71.25 | 0 | 3.75 | 0 | 24.9 | 0 | 0.1 | 12 | 140 | 10.1 | 47.8 | 4.7 |
| 15 | 71.25 | 0 | 3.75 | 0 | 24.9 | 0 | 0.1 | 12 | 140 | 14.7 | 128.8 | 8.8 |
| 16 | 76 | 0 | 4 | 0 | 19.8 | 0 | 0.2 | 10 | 155 | 9.8 | 79.3 | 8.1 |
| 17 | 76 | 0 | 4 | 0 | 19.8 | 0 | 0.2 | 10 | 155 | 11.8 | 98.0 | 8.3 |
| 18 | 68 | 8 | 4 | 0 | 19.8 | 0 | 0.2 | 10 | 155 | 12.0 | 77.0 | 6.4 |
| 19 | 71.25 | 0 | 3.75 | 0 | 24.9 | 0 | 0.1 | 12 | 160 | 9.0 | 42.3 | 4.7 |
| 20 | 66.5 | 8.18 | 4.14 | 0 | 19.8 | 1.18 | 0.2 | 10 | 140 | 12.6 | 87.5 | 7.0 |
| 21 | 60.15 | 8 | 4.14 | 6.53 | 19.8 | 1.18 | 0.2 | 10 | 140 | 17.5 | 173.1 | 9.9 |
| 22 | 68 | 8 | 4 | 0 | 19.8 | 0 | 0.2 | 10 | 140 | 14.4 | 115.4 | 8.0 |
| 23 | 68 | 8 | 4 | 0 | 19.8 | 0 | 0.2 | 12 | 140 | 15.0 | 124.7 | 8.3 |
| 24 | 68 | 8 | 4 | 0 | 19.8 | 0 | 0.2 | 15 | 140 | 15.6 | 127.2 | 8.1 |
| 25 | 65.47 | 8 | 0 | 6.53 | 19.8 | 0 | 0.2 | 10 | 140 | 12.0 | 176.6 | 14.7 |
| 26 | 65.47 | 8 | 0 | 6.53 | 19.8 | 0 | 0.2 | 10 | 140 | 12.0 | 176.6 | 14.7 |
| 27 | 64.29 | 8 | 0 | 6.53 | 19.8 | 1.18 | 0.2 | 10 | 140 | 11.7 | 153.0 | 13.0 |
| 28 | 60.15 | 8 | 4.14 | 6.53 | 19.8 | 1.18 | 0.2 | 10 | 140 | 18.2 | 211.1 | 11.6 |
| 29 | 60.68 | 8 | 4.14 | 6 | 19.8 | 1.18 | 0.2 | 10 | 140 | 16.9 | 207.6 | 12.3 |
| 30 | 61.18 | 8 | 4.14 | 5.5 | 19.8 | 1.18 | 0.2 | 10 | 140 | 17.3 | 204.0 | 11.8 |
| 31 | 62.68 | 8 | 4.14 | 4 | 19.8 | 1.18 | 0.2 | 10 | 140 | 16.3 | 159.3 | 9.8 |
| 32 | 60.15 | 8.53 | 4.14 | 6 | 19.8 | 1.18 | 0.2 | 10 | 140 | 15.7 | 199.0 | 12.7 |
| 33 | 60.15 | 9.03 | 4.14 | 5.5 | 19.8 | 1.18 | 0.2 | 10 | 140 | 17.7 | 180.7 | 10.2 |
| 34 | 60.15 | 10.53 | 4.14 | 4 | 19.8 | 1.18 | 0.2 | 10 | 140 | 16.5 | 141.9 | 8.6 |
| 35 | 60.15 | 8 | 4.14 | 6.53 | 19.8 | 1.18 | 0.2 | 10 | 140 | 18.8 | 221.5 | 11.8 |
| 36 | 64.68 | 8 | 4.14 | 2 | 19.8 | 1.18 | 0.2 | 10 | 140 | 12.9 | 101.8 | 7.9 |
| 37 | 64.7 | 8 | 4.1 | 2 | 19.8 | 1.2 | 0.2 | 10 | 160 | 8.5 | 48.4 | 5.7 |
| 38 | 64.7 | 8 | 4.1 | 2 | 19.8 | 1.2 | 0.2 | 10 | 155 | 10.2 | 63.7 | 6.2 |
| 39 | 64.7 | 8 | 4.1 | 2 | 19.8 | 1.2 | 0.2 | 10 | 140 | 15.4 | 127.3 | 8.3 |
| 40 | 65 | 8 | 4.1 | 2 | 19.8 | 0.9 | 0.2 | 10 | 140 | 15.8 | 133.2 | 8.4 |
| 41 | 65.6 | 8 | 4.1 | 2 | 19.8 | 0.3 | 0.2 | 10 | 140 | 15.4 | 131.8 | 8.5 |
| 42 | 64.7 | 8 | 4.1 | 2 | 19.8 | 1.2 | 0.2 | 10 | 140 | 12.8 | 84.1 | 6.5 |
| 43 | 64.7 | 8 | 4.1 | 2 | 19.8 | 1.2 | 0.2 | 10 | 140 | 14.8 | 114.4 | 7.7 |
| 44 | 60.15 | 8 | 4.14 | 6.53 | 19.8 | 1.18 | 0.2 | 10 | 140 | 17.9 | 206.1 | 11.5 |
| 45 | 66.8 | 8 | 4 | 0 | 19.8 | 1.2 | 0.2 | 10 | 140 | 14.7 | 112.3 | 7.6 |
| 46 | 66.8 | 8 | 4 | 0 | 19.8 | 1.2 | 0.2 | 12 | 140 | 13.1 | 112.5 | 8.6 |
| 47 | 66.8 | 8 | 4 | 0 | 19.8 | 1.2 | 0.2 | 15 | 140 | 13.8 | 127.7 | 9.3 |
| 48 | 64.8 | 8 | 4 | 2 | 19.8 | 1.2 | 0.2 | 15 | 140 | 14.9 | 125.7 | 8.4 |
| 49 | 78.8 | 0 | 0 | 0 | 19.8 | 1.2 | 0.2 | 10 | 140 | 15.5 | 169.8 | 10.9 |
| 50 | 74.2 | 0 | 4.6 | 0 | 19.8 | 1.2 | 0.2 | 10 | 140 | 16.3 | 189.5 | 11.6 |
| 51 | 70.1 | 8.7 | 0 | 0 | 19.8 | 1.2 | 0.2 | 10 | 140 | 14.0 | 100.3 | 7.2 |
| 52 | 56.54 | 7 | 3.5 | 1.74 | 30 | 1.05 | 0.17 | 10 | 140 | 11.0 | 60.6 | 5.5 |
| 53 | 56.54 | 7 | 3.5 | 1.74 | 30 | 1.05 | 0.17 | 20 | 140 | 10.4 | 57.9 | 5.6 |
| 54 | 56.54 | 7 | 3.5 | 1.74 | 30 | 1.05 | 0.17 | 30 | 140 | 9.3 | 55.4 | 5.9 |
| 55 | 48.45 | 6 | 3 | 1.5 | 40 | 0.9 | 0.15 | 10 | 140 | 8.9 | 38.8 | 4.3 |
| 56 | 48.45 | 6 | 3 | 1.5 | 40 | 0.9 | 0.15 | 20 | 140 | 8.1 | 36.5 | 4.5 |
| 57 | 48.45 | 6 | 3 | 1.5 | 40 | 0.9 | 0.15 | 30 | 140 | 7.3 | 32.3 | 4.4 |
| 58 | 66 | 8 | 4 | 2 | 19.8 | 0 | 0.2 | 15 | 140 | 9.9 | 38.4 | 3.9 |
| 59 | 66 | 8 | 4 | 2 | 19.8 | 0 | 0.2 | 30 | 140 | 11.3 | 58.6 | 5.2 |
| 60 | 66.8 | 8 | 4 | 0 | 19.8 | 1.2 | 0.2 | 20 | 140 | 12.8 | 119.2 | 9.3 |
| 61 | 66.8 | 8 | 4 | 0 | 19.8 | 1.2 | 0.2 | 30 | 140 | 12.1 | 108.7 | 9.0 |
| 62 | 64.8 | 8 | 4 | 2 | 19.8 | 1.2 | 0.2 | 20 | 140 | 13.0 | 132.4 | 10.2 |
| 63 | 65.8 | 8 | 4 | 2 | 20 | 0 | 0.2 | 10 | 140 | 13.9 | 116.3 | 8.3 |
| 64 | 68.6 | 8 | 2 | 0 | 20 | 1.2 | 0.2 | 10 | 140 | 12.8 | 96.9 | 7.5 |
| 65 | 64.6 | 8 | 6 | 0 | 20 | 1.2 | 0.2 | 10 | 140 | 13.9 | 116.6 | 8.4 |
| 66 | 67.6 | 8 | 2 | 1 | 20 | 1.2 | 0.2 | 10 | 140 | 14.3 | 107.6 | 7.5 |
| 67 | 65.6 | 8 | 4 | 1 | 20 | 1.2 | 0.2 | 10 | 140 | 15.3 | 102.7 | 6.7 |
| 68 | 63.6 | 8 | 6 | 1 | 20 | 1.2 | 0.2 | 10 | 140 | 15.5 | 106.6 | 6.9 |
| 69 | 78.4 | 0 | 4 | 0 | 15 | 2.4 | 0.2 | 12 | 150 | 11.7 | 183.5 | 15.7 |
| 70 | 78.4 | 0 | 4 | 0 | 15 | 2.4 | 0.2 | 10 | 150 | 9.9 | 121.3 | 12.2 |
| 71 | 78.5 | 0 | 4 | 0 | 15 | 2.4 | 0.1 | 12 | 160 | 10.1 | 117.5 | 11.7 |
| 72 | 78.5 | 0 | 4 | 0 | 15 | 2.4 | 0.1 | 10 | 160 | 10.1 | 120.7 | 12.0 |
| 73 | 63.6 | 0 | 5 | 0 | 30 | 1.2 | 0.2 | 6 | 150 | 8.9 | 42.7 | 4.8 |
| 74 | 63.6 | 0 | 5 | 0 | 30 | 1.2 | 0.2 | 7 | 150 | 8.8 | 42.2 | 4.8 |
| 75 | 73.6 | 0 | 5 | 0 | 20 | 1.2 | 0.2 | 6 | 140 | 15.3 | 124.0 | 8.1 |
| 76 | 73.6 | 0 | 5 | 0 | 20 | 1.2 | 0.2 | 6 | 150 | 11.8 | 86.3 | 7.3 |
| 77 | 63.6 | 8 | 6 | 1 | 20 | 1.2 | 0.2 | 10 | 140 | 10.6 | 103.5 | 9.8 |
| 78 | 64.7 | 8 | 4.1 | 2 | 19.8 | 1.2 | 0.2 | 10 | 140 | 10.9 | 131.4 | 12.1 |
| 79 | 64.7 | 8 | 4.1 | 2 | 19.8 | 1.2 | 0.2 | 10 | 150 | 9.3 | 76.9 | 8.3 |
| 80 | 64.7 | 8 | 4.1 | 2 | 19.8 | 1.2 | 0.2 | 10 | 150 | 9.3 | 76.9 | 8.3 |
| 81 | 64.7 | 8 | 4.1 | 2 | 19.8 | 1.2 | 0.2 | 10 | 155 | 9.9 | 60.8 | 6.1 |
| 82 | 64.7 | 8 | 4.1 | 2 | 19.8 | 1.2 | 0.2 | 10 | 160 | 8.7 | 47.0 | 5.4 |
| 83 | 64.8 | 8 | 4.1 | 2 | 19.8 | 1.2 | 0.1 | 10 | 155 | 11.4 | 66.0 | 5.8 |
| 84 | 68.7 | 8.5 | 4.33 | 2.12 | 15 | 1.25 | 0.1 | 10 | 155 | 12.5 | 108.7 | 8.7 |
| 85 | 71 | 8.8 | 4.5 | 2.2 | 12 | 1.3 | 0.2 | 10 | 155 | 12.4 | 127.5 | 10.3 |
| 86 | 71.1 | 8.8 | 4.5 | 2.2 | 12 | 1.3 | 0.1 | 10 | 155 | 14.6 | 155.5 | 10.6 |
| 87 | 72.6 | 8 | 4.1 | 2 | 12 | 1.2 | 0.1 | 12.5 | 155 | 14.4 | 181.2 | 12.6 |
| 88 | 72.6 | 8 | 4.1 | 2 | 12 | 1.2 | 0.1 | 12.5 | 155 | 14.7 | 180.4 | 12.3 |
| 89 | 72.6 | 8 | 4.1 | 2 | 12 | 1.2 | 0.1 | 12.5 | 155 | 14.3 | 178.1 | 12.5 |
| 90 | 64.6 | 8 | 4.1 | 2 | 20 | 1.2 | 0.1 | 7 | 155 | 12.3 | 68.8 | 5.6 |
| 91 | 71.1 | 8.8 | 4.5 | 2.2 | 12 | 1.3 | 0.1 | 10 | 155 | 15.1 | 161.8 | 10.7 |
| 92 | 71.1 | 8.8 | 4.5 | 2.2 | 12 | 1.3 | 0.1 | 12.5 | 155 | 14.3 | 157.9 | 11.0 |
| 93 | 71.1 | 8.8 | 4.5 | 2.2 | 12 | 1.3 | 0.1 | 15 | 155 | 13.6 | 159.6 | 11.7 |
| 94 | 68.7 | 8.5 | 4.34 | 2.12 | 15 | 1.25 | 0.09 | 10 | 155 | 11.9 | 106.5 | 8.9 |
| 95 | 68.7 | 8.5 | 4.34 | 2.12 | 15 | 1.25 | 0.09 | 12.5 | 155 | 11.0 | 110.6 | 10.0 |
| 96 | 68.7 | 8.5 | 4.34 | 2.12 | 15 | 1.25 | 0.09 | 15 | 155 | 11.0 | 109.0 | 9.9 |
| 97 | 66.26 | 8.2 | 4.2 | 2.05 | 18 | 1.203 | 0.08 | 10 | 155 | 10.7 | 86.9 | 8.2 |
| 98 | 66.26 | 8.2 | 4.2 | 2.05 | 18 | 1.203 | 0.08 | 12.5 | 155 | 9.4 | 80.5 | 8.6 |
| 99 | 66.26 | 8.2 | 4.2 | 2.05 | 18 | 1.203 | 0.08 | 15 | 155 | 10.0 | 83.2 | 8.3 |
| 100 | 81.1 | 0 | 5.5 | 0 | 12 | 1.3 | 0.1 | 10 | 155 | 13.8 | 261.1 | 18.9 |
| 101 | 81.1 | 0 | 5.5 | 0 | 12 | 1.3 | 0.1 | 10 | 155 | 14.0 | 251.8 | 17.9 |
| 102 | 73.72 | 0 | 5 | 0 | 20 | 1.2 | 0.08 | 10 | 155 | 10.8 | 92.0 | 8.5 |
| 103 | 78.8 | 0 | 5.5 | 2.3 | 12 | 1.3 | 0.1 | 10 | 155 | 13.1 | 256.2 | 19.6 |
| 104 | 71.62 | 0 | 5 | 2.1 | 20 | 1.2 | 0.08 | 10 | 155 | 12.8 | 103.6 | 8.1 |
| 105 | 71.62 | 0 | 5 | 2.1 | 20 | 1.2 | 0.08 | 10 | 155 | 14.4 | 130.4 | 9.1 |
| 106 | 75.9 | 4.4 | 4.5 | 2.2 | 12 | 0.9 | 0.1 | 10 | 155 | 11.9 | 218.7 | 18.4 |
| 107 | 79.9 | 0 | 4.74 | 2.31 | 12 | 0.95 | 0.1 | 10 | 155 | 11.3 | 203.3 | 18.1 |
| 108 | 70.71 | 4.58 | 9.38 | 2.29 | 12 | 0.94 | 0.1 | 10 | 155 | 13.0 | 229.2 | 17.6 |
| 109 | 74.61 | 0 | 9.89 | 2.41 | 12 | 0.99 | 0.1 | 10 | 155 | 11.9 | 229.4 | 19.2 |
| 110 | 75.12 | 4.35 | 4.46 | 2.18 | 12 | 1.79 | 0.1 | 10 | 155 | 15.7 | 246.2 | 15.7 |
| 111 | 79.04 | 0 | 4.46 | 2.18 | 12 | 1.79 | 0.1 | 10 | 155 | 13.4 | 269.0 | 20.1 |
| 112 | 69.95 | 4.53 | 9.29 | 2.27 | 12 | 1.86 | 0.1 | 10 | 155 | 15.3 | 245.4 | 16.0 |
| 113 | 73.76 | 0 | 9.79 | 2.38 | 12 | 1.97 | 0.1 | 10 | 155 | 14.5 | 255.4 | 17.6 |
| 114 | 70.71 | 4.1 | 4.2 | 2.05 | 18 | 0.84 | 0.1 | 10 | 155 | 13.4 | 107.5 | 8.0 |
| 115 | 74.46 | 0 | 4.41 | 2.15 | 18 | 0.88 | 0.1 | 10 | 155 | 15.3 | 151.3 | 9.9 |
| 116 | 65.88 | 4.27 | 8.74 | 2.13 | 18 | 0.88 | 0.1 | 10 | 155 | 14.2 | 117.3 | 8.2 |
| 117 | 69.5 | 0 | 9.22 | 2.25 | 18 | 0.93 | 0.1 | 10 | 155 | 14.6 | 147.9 | 10.1 |
| 118 | 69.98 | 4.06 | 4.16 | 2.03 | 18 | 1.67 | 0.1 | 10 | 155 | 12.9 | 113.1 | 8.8 |
| 119 | 73.63 | 0 | 4.37 | 2.14 | 18 | 1.76 | 0.1 | 10 | 155 | 14.0 | 152.1 | 10.9 |
| 120 | 65.17 | 4.24 | 8.65 | 2.11 | 18 | 1.73 | 0.1 | 10 | 155 | 13.6 | 106.8 | 7.9 |
| 121 | 68.71 | 0 | 9.13 | 2.23 | 18 | 1.83 | 0.1 | 10 | 155 | 14.1 | 153.2 | 10.9 |
| 122 | 64.8 | 8 | 4.1 | 2 | 19.8 | 1.2 | 0.1 | 8 | 155 | 12.2 | 77.6 | 6.4 |
| 123 | 71.62 | 0 | 3 | 4.1 | 20 | 1.2 | 0.08 | 10 | 155 | 15.0 | 154.6 | 10.3 |
| 124 | 72.6 | 8 | 4.1 | 2 | 12 | 1.2 | 0.1 | 12.5 | 156 | 13.3 | 152.4 | 11.5 |
| 125 | 72.3 | 8 | 4.1 | 2 | 12 | 1.5 | 0.1 | 12.5 | 156 | 13.9 | 168.0 | 12.1 |
| 126 | 71.8 | 8 | 4.1 | 2 | 12 | 2 | 0.1 | 12.5 | 156 | 13.0 | 158.8 | 12.2 |
| 127 | 72.4 | 8 | 4.1 | 2 | 12 | 1.3 | 0.3 | 12.5 | 155 | 10.3 | 131.5 | 12.8 |
| 128 | 72.6 | 8 | 4.1 | 2 | 12 | 1.3 | 0.1 | 12.5 | 155 | 12.9 | 171.3 | 13.2 |
| 129 | 72.6 | 8 | 4.1 | 2 | 12 | 1.3 | 0.1 | 12.5 | 150 | 14.7 | 189.4 | 12.9 |
| 130 | 81.1 | 0 | 5.5 | 0 | 12 | 1.3 | 0.1 | 12.5 | 155 | 12.2 | 227.0 | 18.6 |
| 131 | 81.5 | 0 | 5.6 | 0 | 12 | 0.8 | 0.1 | 12.5 | 155 | 11.3 | 204.2 | 18.1 |
| 132 | 81.8 | 0 | 5.7 | 0 | 12 | 0.4 | 0.1 | 12.5 | 155 | 11.2 | 191.9 | 17.1 |
| 133 | 81.8 | 0 | 5.7 | 0 | 12 | 0.4 | 0.1 | 12.5 | 155 | 11.1 | 215.8 | 19.5 |
| 134 | 71.6 | 0 | 5 | 2.1 | 20 | 1.2 | 0.1 | 12.5 | 155 | 12.6 | 114.3 | 9.1 |
| 135 | 71.6 | 0 | 5 | 2.1 | 20 | 1.2 | 0.1 | 12.5 | 165 | 9.3 | 60.6 | 6.5 |
| 136 | 76.8 | 0 | 11 | 0 | 12 | 0 | 0.2 | 10 | 168.9 | 9.4 | 116.0 | 12.3 |
| 137 | 76.8 | 0 | 11 | 0 | 12 | 0 | 0.2 | 10 | 171.1 | 9.7 | 116.2 | 12.0 |
| 138 | 76.8 | 0 | 11 | 0 | 12 | 0 | 0.2 | 10 | 173.9 | 8.4 | 92.0 | 10.9 |
| 139 | 68 | 11.3 | 8.5 | 0 | 12 | 0 | 0.2 | 10 | 167.2 | 10.1 | 78.2 | 7.7 |
| 140 | 69.8 | 0 | 18 | 0 | 12 | 0 | 0.2 | 10 | 160 | 9.8 | 176.0 | 17.9 |
| 141 | 79.8 | 0 | 8 | 0 | 12 | 0 | 0.2 | 10 | 173.9 | 8.0 | 65.9 | 8.2 |

PI is the polymerizable photoinitiator;
Init is free radical initiator;
RT is the residence time;
and Tr is reactor temperature.

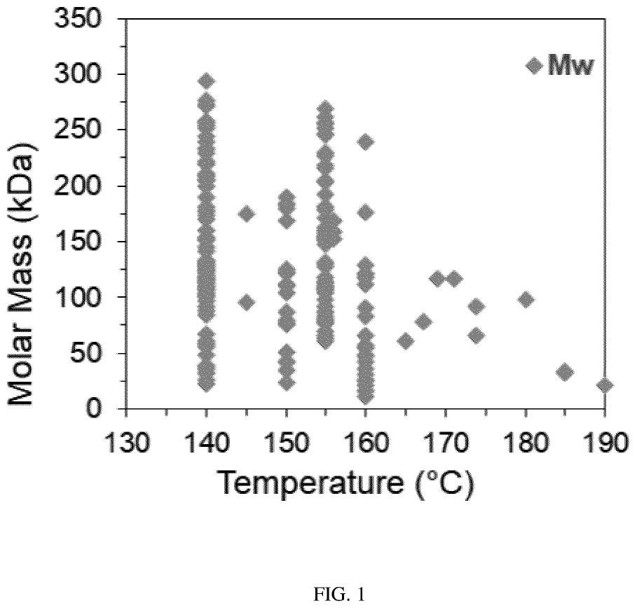

For many of these examples, molar mass (kDa) versus temperature (° C.) are plotted in FIG. 1.

Para. 1. A process for continuously preparing a polymer by free-radical polymerization, the process comprising:
continuously feeding to a reactor a mixture comprising:
   about 20 wt % to about 96 wt % of a vinylic monomer, the vinylic monomer comprising a styrenic monomer, a (meth)acrylic monomer, or a mixture thereof;
   greater than 0 wt % to about 0.25 wt % of a polymerization initiator; and
   about 4 wt % to about 80 wt % of a reaction solvent;
maintaining the reactor at a temperature from about 120° C. to about 190° C.; and collecting the polymer;
wherein:

the polymer has a weight-average molecular weight (M_{w}) from about 20,000 g/mol to about 300,000 g/mol.

Para. 2. The process of Para. 1, wherein the vinylic monomer comprises a styrenic monomer and a (meth)acrylic monomer.

Para. 3. The process of Para. 1, wherein the vinylic monomer comprises a (meth)acrylic monomer.

Para. 4. The process of any one of Paras. 1-3, wherein the polymerization initiator comprises an azo compound, a peroxide, or a mixture of any two or more thereof.

Para. 5. The process of any one of Paras. 1-6, wherein the polymerization initiator comprises 2,2′-azodi-(2,4-dimethylvaleronitrile); 2,2′-azobisisobutyronitrile (AIBN); 2,2′-azobis(2-methylbutyronitrile); 1,1′-azobis (cyclohexane-1-carbonitrile); tertiary butylperbenzoate; tert-amyl peroxy 2-ethylhexyl carbonate; 1,1-bis(tert-amylperoxy)cyclohexane, tert-amylperoxy-2-ethylhexanoate, tert-amylperoxyacetate, tert-butylperoxyacetate, tert-butylperoxybenzoate, 2,5-di-(tert-butylperoxy)-2,5-dimethylhexane, di-tert-amyl peroxide (DTAP); di-tert-butylperoxide (DTBP); lauryl peroxide; dilauryl peroxide, succinic acid peroxide; or benzoyl peroxide.

Para. 6. The process of any one of Paras. 1-5, wherein the reaction solvent comprises acetone, aromatic 100, aromatic 150, aromatic-200, ethyl-3-ethoxypropionate, methyl amyl ketone, methylethylketone, methyl-iso-butylketone, N-methylpyrrolidone, (propylene glycol monomethyl ether acetate, xylene, toluene, ethyl benzene, carbitol, cyclohexanol, dipropylene glycol (mono)methyl ether, n-butanol, n-hexanol, hexyl carbitol, iso-octanol, iso-propanol, methyl cyclohexane methanol, decyl alcohol, lauryl alcohol, myristal alcohol, cetyl alcohol, stearyl alcohol, behenyl alcohol, or isoparaffins.

Para. 7. The process of any one of Paras. 1-6, wherein the (meth)acrylic monomer comprises ethyl acrylate, methyl (meth)acrylate, butyl (meth)acrylate, 2-ethylhexyl (meth)acrylate, hydroxyethyl (meth)acrylate, glycidyl (meth)acrylate, acrylic acid, (meth)acrylic acid, hydroxy propyl (meth)acrylate, or hydroxy butyl(meth)acrylate.

Para. 8. The process of any one of Paras. 1-6, wherein the styrenic monomer comprises styrene or α-methylstyrene.

Para. 9. The process of any one of Paras. 1-8, wherein the styrenic monomer comprises styrene and the (meth)acrylic monomer comprises glycidyl (meth)acrylate.

Para. 10. The process of any one of Paras. 1-9, wherein the vinylic monomer comprises from about 40 to about 65 wt % of the styrenic monomer; and from about 35 to about 60 wt % (meth)acrylic monomer.

Para. 11. The process of any one of Paras. 1-10, wherein the polymerization initiator is present from about 0.01 wt % to about 0.25 wt %, based upon the solids of the reaction.

Para. 12. The process of any one of Paras. 1-11 further comprising a polymerizable photoinitiator.

Para. 13. The process of Para. 12, wherein the polymerizable photoinitiator is a compound of formula:

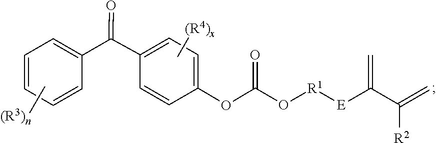

wherein:

R¹ is a linker group;

R² is H or alkyl;

E is O or NR⁵;

each R³ is individually a substituent selected from the group consisting of R³ is individually a substituent selected from the group consisting of halogen, alkyl, O-alkyl, cycloalkyl, and an alkyl group containing a heteroatom, a halogen, a carbonyl group, alkoxy, or amino group;

each R⁴ is individually a substituent selected from the group consisting of R³ is individually a substituent selected from the group consisting of halogen, alkyl, O-alkyl, cycloalkyl, and an alkyl group containing a heteroatom, a halogen, a carbonyl group, alkoxy, or amino group;

R⁵ is H or alkyl;

n is 0-5; and

x is 0-4.

Para. 14. The process of Para. 13, wherein:
R¹ is arylene, cycloalkylenyl, —[C(R⁶)(R⁷)]_{n′}—, or —{[C(R⁶)(R⁷)]_{n′}C(O)}_{x′}[O(C(R⁶)(R⁷))_{q}]ₚ—;

each R⁶ is individually H, OR¹⁰, alkyl, or C(O)OH;

each R⁷ is individually H, OR¹⁰, or alkyl;

each R¹⁰ is individually H or alkyl;

n′ is 1-12;

q is 1, 2, or 3;

p is 1, 2, or 3; and

x′ is 1-10.

Para. 15. The process of any one of Paras. 12 or 13, wherein R¹ is —(CH₂)_{n′}—, cyclohexan-1,4-yl, phenylen-1,4-yl, —[(CH₂)₃C(O)]₂—O—(CH₂)_{q}—, —C(CH₃)(C(O)OH)—, —C(H)(phenyl)C(CH₃)(H)—, or —CH₂C(CH₃)₂CH₂—; and q is 1, 2, or 3.

Para. 16. The process of any one of Paras. 13, 14, or 15, wherein R¹ is —(CH₂)₃—; E is O; n is 0, x is 0, and R² is H or methyl.

Para. 17. The process of any one of Paras. 13-16, wherein the polymerizable photoinitiator is present from about 0.01 wt % to about 5 wt %, based upon the solids of the reaction.

Para. 18. The process of any one of Paras. 1-17, wherein the mixture further comprises N-vinyl pyrrolidone from >0 to ≤15 wt %, based upon the solids of the reaction.

Para. 19. The process of any one of Paras. 1-18, wherein the (meth)acrylic monomer comprises acrylic acid, methacrylic acid, methylmethacrylic acid, methylmethacrylate, ethylmethacrylate, a hydroxy vinyl ether, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate, methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate, tetrahydropyranyl methacrylate, hydroxyalkyl acrylates and methacrylates, acrylic acid and its salts, acrylonitrile, acrylamide, methyl α-chloroacrylate, methyl 2-cyanoacrylate, N-ethylacrylamide, N,N-diethylacrylamide, acrolein, methacrylic acid and its salts, methacrylonitrile, methacrylamide, N-methylmethacrylamide, N-ethylmethacrylamide, N,N-diethylmethacrylamide, N,N-dimethylmethacrylamide, N-phenylmethacrylamide, methacrolein, or a mixture of any two or more thereof.

Para. 20. The process of any one of Paras. 1-19, wherein the (meth)acrylate comprises an alkanol (meth)acrylate ester.

Para. 21. The process of any one of Paras. 1-20, wherein the (meth)acrylate comprises methyl (meth)acrylate.

Para. 22. The process of any one of Paras. 1-21, wherein the weight average molecular weight (M_{w}) is from about 30,000 g/mol to 300,000 g/mol.

Para. 23. The process of Para. 22, wherein the weight average molecular weight (M_{w}) is from about 30,000 g/mol to 250,000 g/mol.

Para. 24. The process of any one of Paras. 22 or 23, wherein the weight average molecular weight (M_{w}) is from about 35,000 g/mol to 200,000 g/mol.

Para. 25. The process of any one of Paras. 22-24, wherein the weight average molecular weight (M_{w}) is from about 35,000 g/mol to 150,000 g/mol.

Para. 26. A process for producing a styrenic (meth)acrylic polymer, the process comprising: continuously charging into a reactor a mixture comprising: a styrenic monomer; a (meth)acrylic monomer; and from about >0 wt % to about 0.25 wt % of a polymerization initiator; maintaining the mixture at a temperature from about 120° C. to about 190° C.; and isolating a styrenic (meth)acrylic polymer from the mixture; wherein the weight average molecular weight (M_{w}) is from about 20,000 g/mol to 300,000 g/mol.

Para. 27. A pressure sensitive adhesive comprising the polymer produced by the process of any one of Paras. 1-26 and a backing material.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A process for continuously preparing a polymer by free-radical polymerization, the process comprising:
continuously feeding to a reactor a mixture comprising:
about 20 wt % to about 96 wt % of a vinylic monomer, the vinylic monomer comprising at least one selected from the group consisting of a styrenic monomer, a (meth)acrylic monomer, and a mixture thereof;
greater than 0 wt % to about 0.25 wt % of a polymerization initiator; and
about 4 wt % to about 80 wt % of a reaction solvent;
maintaining the reactor at a temperature from about 120° C. to about 190° C.; and
collecting the polymer;
wherein the polymer has a weight-average molecular weight (M_{w}) from about 20,000 g/mol to about 300,000 g/mol.

2. The process of claim 1, wherein the vinylic monomer comprises a styrenic monomer and a (meth)acrylic monomer.

3. The process of claim 1, wherein the vinylic monomer comprises a (meth)acrylic monomer.

4. The process of claim 1, wherein the polymerization initiator comprises at least one selected from the group consisting of an azo compound, a peroxide, and a mixture of any two or more thereof.

5. The process of claim 1, wherein the polymerization initiator comprises at least one selected from the group consisting of 2,2′-azodi-(2,4-dimethylvaleronitrile), 2,2′-azobisisobutyronitrile (AIBN), 2,2′-azobis(2-methylbutyronitrile), 1,1′-azobis (cyclohexane-1-carbonitrile), tertiary butylperbenzoate, tert-amyl peroxy 2-ethylhexyl carbonate, 1,1-bis(tert-amylperoxy)cyclohexane, tert-amylperoxy-2-ethylhexanoate, tert-amylperoxyacetate, tert-butylperoxyacetate, tert-butylperoxybenzoate, 2,5-di-(tert-butylperoxy)-2,5-dimethylhexane, di-tert-amyl peroxide (DTAP), di-tert-butylperoxide (DTBP), lauryl peroxide, dilauryl peroxide, succinic acid peroxide, and benzoyl peroxide.

6. The process of claim 1, wherein the reaction solvent comprises at least one selected from the group consisting of acetone, aromatic 100, aromatic 150, aromatic-200, ethyl-3-ethoxypropionate, methyl amyl ketone, methylethylketone, methyl-iso-butylketone, N-methylpyrrolidone, (propylene glycol monomethyl ether acetate, xylene, toluene, ethyl benzene, carbitol, cyclohexanol, dipropylene glycol (mono)methyl ether, n-butanol, n-hexanol, hexyl carbitol, iso-octanol, iso-propanol, methyl cyclohexane methanol, decyl alcohol, lauryl alcohol, myristal alcohol, cetyl alcohol, stearyl alcohol, behenyl alcohol, and an isoparrafin.

7. The process of claim 1, wherein the vinylic monomer comprises a (meth)acrylic monomer, and
wherein the (meth)acrylic monomer comprises at least one selected from the group consisting of ethyl acrylate, methyl (meth)acrylate, butyl (meth)acrylate, 2-ethylhexyl (meth)acrylate, hydroxyethyl (meth)acrylate, glycidyl (meth)acrylate, acrylic acid, (meth)acrylic acid, hydroxy propyl (meth)acrylate, and hydroxy butyl(meth)acrylate.

8. The process of claim 1, wherein the vinylic monomer comprises a styrenic monomer, and
wherein the styrenic monomer comprises styrene or α-methylstyrene.

9. The process of claim 1, wherein the vinylic monomer comprises a styrenic monomer and a meth(acrylate) monomer,
wherein the styrenic monomer comprises styrene and
wherein the (meth)acrylic monomer comprises glycidyl (meth)acrylate.

10. The process of claim 1, wherein the vinylic monomer comprises from about 40 to about 65 wt % of the styrenic monomer, and from about 35 to about 60 wt % of a (meth)acrylic monomer based on a total weight of the vinylic monomer.

11. The process of claim 1, wherein the polymerization initiator is present from about 0.01 wt % to about 0.25 wt %, based upon the solids of the reaction.

12. The process of claim 1, wherein the mixture further comprises a polymerizable photoinitiator.

13. The process of claim 1, wherein the mixture further comprises a polymerizable photoinitiator having a formula: 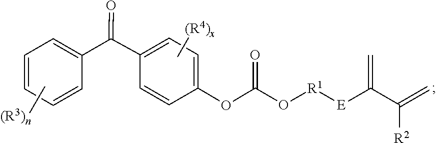
wherein:
R¹ is a linker group;
R² is H or alkyl;
E is O or NR⁵;
each R³ is independently at least one selected from the group consisting of halogen, alkyl, O-alkyl, cycloalkyl, and an alkyl group containing a heteroatom, a halogen, a carbonyl group, alkoxy, and an amino group;
each R⁴ is independently at least one selected from the group consisting of halogen, alkyl, O-alkyl, cycloalkyl, and an alkyl group containing a heteroatom, a halogen, a carbonyl group, alkoxy, and an amino group;
R⁵ is H or alkyl;
n is 0-5; and
x is 0-4.

14. The process of claim 13, wherein:
R₁ is at least one selected from the group consisting of arylene, cycloalkylenyl, —[C(R⁶)(R⁷)]_{n′}—, and —{[C(R⁶)(R⁷)]_{n′}C(O)}_{x′}[O(C(R⁶)(R⁷))_{q}]ₚ—;
each R⁶ is independently at least one selected from the group consisting of H, OR¹⁰, alkyl, and C(O)OH;
each R⁷ is independently at least one selected from the group consisting of H, OR¹⁰, and alkyl;
each R¹⁰ is independently H or alkyl;
n′ is 1-12;
q is 1, 2, or 3;
p is 1, 2, or 3; and
x′ is 1-10.

15. The process of claim 12, wherein R¹ is at least one selected from the group consisting of —(CH₂)_{n′}—, cyclohexan-1,4-yl, phenylen-1,4-yl, —[(CH₂)₃C(O)]₂—O—(CH₂)_{q}—, —C(CH₃)(C(O)OH)—, —C(H)(phenyl)C(CH₃)(H)—, and —CH₂C(CH₃)₂CH₂—; and
wherein q is 1, 2, or 3.

16. The process of claim 13, wherein R¹ is —(CH₂)₃—; E is O; n is O; x is 0; and R² is H or methyl.

17. The process of claim 13, wherein the polymerizable photoinitiator is present from about 0.01 wt % to about 5 wt %, based upon the solids of the reaction.

18. The process of claim 1, wherein the mixture further comprises N-vinyl pyrrolidone from >0 to ≤15 wt %, based upon the solids of the reaction.

19. The process of claim 1, wherein the vinylic monomer comprises a meth(acrylate) monomer, and
wherein the (meth)acrylic monomer comprises at least one selected from the group consisting of acrylic acid, methacrylic acid, methylmethacrylic acid, methylmethacrylate, ethylmethacrylate, a hydroxy vinyl ether, methyl acrylate, ethyl acrylate, n-propyl acrylate, isopropyl acrylate, n-butyl acrylate, n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate, tetrahydropyranyl acrylate, methyl methacrylate, ethyl methacrylate, n-propyl methacrylate, n-butyl methacrylate, isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate, benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate, tetrahydropyranyl methacrylate, hydroxyalkyl acrylates, hydroxyalkyl methacrylates, acrylic acid, a salt of acrylic acid, acrylonitrile, acrylamide, methyl α-chloroacrylate, methyl 2-cyanoacrylate, N-ethylacrylamide, N,N-diethylacrylamide, acrolein, methacrylic acid, a salt of methacrylic acid, methacrylonitrile, methacrylamide, N-methylmethacrylamide, N-ethylmethacrylamide, N,N-diethylmethacrylamide, N,N-dimethylmethacrylamide, N-phenylmethacrylamide, methacrolein, and a mixture of any two or more thereof.

20. The process of claim 1, wherein the vinylic monomer comprises a meth(acrylate) monomer, and the (meth)acrylate monomer comprises an alkanol (meth)acrylate ester.

21. The process of claim 1, wherein the vinylic monomer comprises a meth(acrylate) monomer, and the (meth)acrylate monomer comprises methyl (meth)acrylate.

22. The process of claim 1, wherein the weight average molecular weight (M_{w}) is from about 30,000 g/mol to 300,000 g/mol.

23. The process of claim 22, wherein the weight average molecular weight (M_{w}) is from about 30,000 g/mol to 250,000 g/mol.

24. The process of claim 23, wherein the weight average molecular weight (M_{w}) is from about 35,000 g/mol to 200,000 g/mol.

25. The process of claim 24, wherein the weight average molecular weight (M_{w}) is from about 35,000 g/mol to 150,000 g/mol.

26. A process for producing a styrenic (meth)acrylic polymer, the process comprising:
continuously charging into a reactor a mixture comprising:
a styrenic monomer;
a (meth)acrylic monomer; and
from about >0 wt % to about 0.25 wt % of a polymerization initiator;
maintaining the mixture at a temperature from about 120° C. to about 190° C.; and
isolating a styrenic (meth)acrylic polymer from the mixture;
wherein the weight average molecular weight (M_{w}) of the styrenic (meth)acrylic polymer is from about 20,000 g/mol to 300,000 g/mol.

27. A pressure sensitive adhesive, comprising: the polymer produced by the process of claim 1, and a backing material.
